(19) United States
(12) Patent Application Publication
(10) Pub. No.: US 2005/0138857 A1
(43) Pub. Date: Jun. 30, 2005

(54) Transmitting control device for a navigable fishing apparatus and a fishing pole and transmitter assembly

(76) Inventors: Duane C. Markley, Spokane Valley, WA (US); Ron Stokes, Spokane Valley, WA (US)

Correspondence Address: WELLS ST. JOHN P.S., 601 W. FIRST AVENUE, SUITE 1300, SPOKANE, WA, 99201, US

(21) Appl. No.: 10/998,200

(22) Filed: Nov. 26, 2004

Related U.S. Application Data
(60) Provisional application No. 60/525,589, filed on Nov. 26, 2003.

(51) Int. Cl. A01K 85/00

(52) U.S. Cl. 43/26.2

(57) ABSTRACT

A transmitting control device is provided for a navigable fishing apparatus. The control device includes a fishing pole, a transmitter, and at least one input device. The fishing pole has a handle component. The transmitter is provided in the handle component. The at least one input device is supported by the handle and is electrically coupled with the transmitter to generate input signals from the transmitting control device for controlling a remotely-controlled and navigable fishing apparatus.

### RELATED PATENT DATA

This application claims the benefit of U.S. Provisional Patent Application Ser. No. 60/525,589, which was filed on Nov. 26, 2003, and which is incorporated by reference herein and made a part hereof.

### TECHNICAL FIELD

The present invention pertains to a remote-controlled and self-propelled navigable fishing apparatus. More particularly, the present invention relates to transmitting control devices for use with remote-controlled and self-propelled fishing bobbers and fishing lures used in conjunction with fishing poles.

### BACKGROUND OF THE INVENTION

Numerous attempts have been made to realize navigable fishing apparatus, such as remote-controlled and self-propelled bobbers and fishing lures.

In one case, remote-controlled, miniature fishing boats have been utilized to deliver a lure to a desired location within a body of water. For example, U.S. Pat. Nos. 3,203,131; 5,293,712; 6,041,537; 6,263,611; and 6,520,105, herein incorporated by reference, are directed to such remote-controlled, unmanned fishing vessels. These various inventions are directed to devices that enable an angler to remotely position a lure or bait within a body of water. However, these miniaturized unmanned fishing devices are not capable of being affixed onto an existing fishing line and cast by an angler into a body of water. Secondly, improvements are needed in the manner in which input signals are delivered to such devices for remotely navigating the devices within a body of water.

Secondly, various devices are directed towards remotely controlling a fishing bobber within a navigable body of water. For example, U.S. Pat. Nos. 4,638,585 and 5,086,581, herein incorporated by reference, are directed to fishing bobbers that contain a propulsion unit and a remotely-controlled system for navigating the bobber within a body of water. Although these devices enable an angler to navigate the positioning of a bobber within a body of water, improvements are needed in the manner in which input signals are delivered to such devices when navigating the devices within a body of water.

Thirdly, self-propelled fishing devices in the form of fishing lures are also known in the art. U.S. Pat. Nos. 5,077,929 and 6,760,995, herein incorporated by reference, disclose self-propelled and navigable fishing lures that can be remotely controlled and navigated within a body of water, including at various depths and plan view locations within the water. However, improvements are needed in the manner in which input signals are delivered to such devices when navigating the devices within a body of water.

Finally, various devices are known for remotely transmitting control signals to a remote-controlled and self-propelled fishing apparatus. By way of example, U.S. Pat. Nos. 5,463,597; 6,584,722; and 6,758,006, herein incorporated by reference, show various fishing poles that include a control module that has transmitting circuitry that is attached onto an exterior portion of a fishing pole. However, these electronic modules tend to be rather bulky and obtrusive, and inhibit an angler's casting technique. Accordingly, improvements are needed, particularly when incorporating transmitting control circuitry into a relatively compact fishing pole where existing control modules already tend to be rather bulky and obtrusive.

### SUMMARY OF THE INVENTION

A fishing apparatus, such as a fishing bobber or a fishing lure, is provided in combination with a transmitter control device that is incorporated inside a handle component of a fishing pole to enable remote control of the apparatus, which is also self-propelled and navigable. According to one construction, the remote-controlled and self-propelled apparatus comprises a fishing bobber. According to another construction, the remote-controlled and self-propelled apparatus comprises a fishing lure. According to one construction, the transmitting control device comprises remote control transmitting circuitry that is installed within a handle of a fishing pole. The fishing apparatus is provided with a propulsion mechanism and steering mechanisms in conjunction with the control circuitry to enable navigation of the fishing apparatus along desired paths and in desired locations across or within a body of water.

According to one aspect, a transmitting control device is provided for a navigable fishing apparatus. The control device includes a fishing pole, a transmitter, and at least one input device. The fishing pole has a handle component. The transmitter is provided in the handle component. The at least one input device is supported by the handle and is electrically coupled with the transmitting control device to generate input signals from the transmitting control device for controlling a remotely-controlled and navigable fishing apparatus.

A fishing pole, a fishing bobber, and a fishing lure are provided with remote controls installed in the handle of the pole (or in a separate control unit) and receivers along with a propulsion mechanism and steering mechanisms are installed in the bobber or lure. This allows any angler to control various axes of movement of the bobber or lure from the handle of the angler's pole or via a separate control unit. This also allows the angler to place the bobber or lure in the position he chooses without repetitive casting efforts, or if he wants, he can also choose not to cast. Instead, he can physically start the bobber or lure at his side and control it to the location he wants.

According to one aspect, a fishing pole is provided with a radio frequency (RF) radio or infrared (IR) transmitter and functional user controls. The bobber or lure is provided with a radio receiver that receives signals from the transmitter and in turn supplies the signal to the servo and electric motor. The servo then supplies the function of steering the bobber or lure by moving linkages attached to a rudder placed at the stern of the bobber or lure. The electric motor supplies the function of moving the bobber or lure either forward or backward by turning a propeller that resides at the stern and outside the body of the bobber or the lure. The power is provided by rechargeable batteries such as NiCads, Li-Poly or NiMH or non-rechargeable batteries such as alkaline batteries. The angler supplies input to the user controls on the handle and the signal is transmitted from the transmitter in the handle to the receiver in the bobber or lure.

According to another aspect, a fishing pole is provided with a radio frequency (RF) radio or infrared (IR) transmitter and functional user controls. The bobber or lure is provided with a radio receiver that receives signals from the transmitter and in turn supplies the signal to actuators and an electric motor. The actuators then supply the function of steering the bobber or lure by moving the rudder placed at the stern of the bobber or lure. The electric motor supplies the function of moving the bobber or lure either forward or backward by turning a propeller that resides at the stern and outside the body of the bobber or the lure.

According to another aspect, a fishing pole is provided with a radio frequency (RF) radio or infrared (IR) transmitter and functional user controls. The bobber or lure is provided with a radio receiver that receives signs from the transmitter and in turn supplies an electrical charge to current controlled wire that in turn changes length as a charge is applied or removed causing the rudder to move to one side or the other. The electric motor supplies the function of moving the bobber or lure either forward or backward by turning a propeller that resides at the stern and outside the body of the bobber or the lure.

According to another aspect, a fishing pole is provided with a radio frequency (RF) radio or infrared (IR) transmitter and functional user controls. The bobber or lure is provided with a radio receiver that receives signals from the transmitter and in turn supplies a signal to an electrical motor or several motors that turn a series of gears and move a rudder to one side or the other. The electric motor supplies the function of moving the bobber or lure either forward or backward by turning a propeller that resides at the stern and outside the body of the bobber or the lure.

According to still another aspect, a fishing pole is provided with a radio frequency (RF) radio or infrared (IR) transmitter and functional user controls. The bobber or lure is provided with a radio receiver that receives signals from the transmitter and in turn supplies the signal to the servo and electric motors. The serve then supplies the function of steering the bobber or lure by moving an articulating fin/body of the bobber or lure. The electric motor supplies the function of moving the bobber or lure either forward or backward by turning a propeller that resides at the stern and outside the body of the bobber or the lure.

According to another aspect, a fishing pole is provided with a radio frequency (RF) radio or infrared (IR) transmitter and functional user controls. The bobber or lure is provided with a radio receiver that receives signals from the transmitter and in turn supplies the signal to actuators and an electric motor. The actuators then supply the function of steering the bobber or lure by moving an articulating fin/body. The electric motor supplies the function of moving the bobber or lure either forward or backward by turning a propeller that resides at the stern and outside the body of the bobber or the lure.

According to another aspect, a fishing pole is provided with a radio frequency (RF) radio or infrared (IR) transmitter and functional user controls. The bobber or lure is provided with a radio receiver that receives signals from the transmitter and in turn supplies an electrical charge to current controlled wire that in turn changes length as a charge is applied or removed causing the articulating fin/body to move to one side or the other. The electric motor supplies the function of moving the bobber or lure either forward or backward by turning a propeller that resides at the stern and outside the body of the bobber or the lure.

According to another aspect, a fishing pole is provided with a radio frequency (RF) radio or infrared (IR) transmitter and functional user controls. The bobber or lure is provided with a radio receiver that receives signals from the transmitter and in turn supplies a signal to an electrical motor or several motors that turn a series of gears and move an articulating fin/body to one side or the other. The electric motor supplies the function of moving the bobber or lure either forward or backward by turning a propeller that resides at the stern and outside the body of the bobber or the lure.

According to still another aspect, a fishing pole is provided with a radio frequency (RF) radio or infrared (IR) transmitter and functional user controls. The bobber or lure is provided with a radio receiver and functional user controls. The bobber or lure is provided with a radio receiver that receives signals from the transmitter and in turn supplies the signal to the servo and electric motors. The servo motor then supplies the function of steering the bobber or lure by moving and articulating jet drive. The electric motor supplies the function of moving the bobber or lure either forward or backward by turning a jet drive that resides at the stern and outside the body of the bobber or the lure.

According to another aspect, a fishing pole is provided with a radio frequency (RF) radio or infrared transmitter and functional user control. The bobber or lure is provided with a radio receiver that receives signals from the transmitter and in turn supplies the signal to actuators and an electric motor. The actuators then supply the function of steering the bobber or lure by moving an articulating jet drive. The electric motor supplies the function of moving the bobber or lure either forward or backward by turning a jet drive that resides at the stern and outside the body of the bobber or the lure.

According to another aspect, a fishing pole is provided with a radio frequency (RF) radio or infrared (IR) transmitter and functional user controls. The bobber or lure is provided with a radio receiver that receives signals from the transmitter and in turn supplies an electrical charge to current-controlled wire that in turn changes length as a charge is applied or removed causing the articulating jet drive to move to one side or the other. The electric motor supplies the function of moving the bobber or lure either forward or backward by turning a jet drive that resides at the stern and outside the body of the bobber or the lure.

According to another aspect, a fishing pole is provided with a radio frequency (RF) radio or infrared (IR) transmitter and functional user controls. The bobber or lure is provided with a radio receiver that receives signals from the transmitter and in turn supplies a signal to an electrical motor or several motors that turn a series of gears and move an articulating jet drive to one side or the other. The electric motor supplies the function of moving the bobber or lure either forward or backward by turning a jet drive that resides at the stem and outside the body of the bobber or lure.

According to another aspect, a fishing pole is provided with a radio frequency (RF) radio or infrared (IR) transmitter and functional user controls. The bobber or lure is provided with a radio receiver that receives signals from the transmitter and in turn supplies the signal to the servo and electric motors. The servo motor then supplies the function of steering the bobber or lure by moving linkages attached to a rudder placed at the stern of the bobber or lure. The electric motor supplies the function of moving the bobber or lure either forward or backward by turning an impeller.

According to another aspect, a fishing pole is provided with a radio frequency (RF) radio or infrared (IR) transmitter and functional user controls. The bobber or lure is provided with a radio receiver that receives signals from the transmitter and in turn supplies the signal to actuators and an electric motor. The actuators then supply the function of steering the bobber or lure by moving the rudder placed at the stern of the bobber or lure. The electric motor supplies the function of moving the bobber or lure either forward or backward by turning an impeller.

According to another aspect, a fishing pole is provided with a radio frequency (RF) radio or infrared (IR) transmitter and functional user controls. The bobber or lure is provided with a radio receiver that receives signals from the transmitter and in turn supplies an electrical charge to current-controlled wire that in turn changes length as a charge is applied or removed causing the rudder to move to one side or the other. The electric motor supplies the function of moving the bobber or lure either forward or backward by turning an impeller.

According to another aspect, a fishing pole is provided with a radio frequency (RF) radio or infrared (IR) transmitter and functional user controls. The bobber or lure is provided with a radio receiver and functional user controls. The bobber or lure is provided with a radio receiver that receives signals from the transmitter and in turn supplies a signal to an electrical motor or several motors that turns a series of gears and moves a rudder to one side or the other. The electric motor supplies the function of moving the bobber or lure either forward or backward by turning an impeller.

According to still another aspect, a fishing pole is provided with a radio frequency (RF) radio or infrared (IR) transmitter and functional user controls. The bobber or lure is provided with a radio receiver that receives signals from the transmitter and in turn supplies the signal to the servo and electric motors. The servo then supplies the function of steering the bobber or lure by moving an articulating fin/body of the bobber or lure. The electric motor supplies the function of moving the bobber or lure either forward or backward by turning an impeller.

According to another aspect, a fishing pole is provided with a radio frequency (RF) radio or infrared (IR) transmitter and functional user controls. The bobber or lure is provided with a radio receiver that receives signals from the transmitter and in turn supplies the signal to actuators and an electric motor. The actuators then supply the function of steering the bobber or lure by moving an articulating fin/body. The electric motor supplies the function of moving the bobber or lure either forward or backward by turning an impeller.

According to another aspect, a fishing pole is provided with a radio frequency (RF) radio or infrared (IR) transmitter and functional user controls. The bobber or lure is provided with a radio receiver that receives signals from the transmitter and in turn supplies an electrical charge to current-controlled wire that in turn changes length as a charge is applied or removed causing the articulating fin/body to move to one side or the other. The electric motor supplies the function of moving the bobber or lure either forward or backward by turning an impeller.

According to another aspect, a fishing pole is provided with a radio frequency (RF) radio or infrared (IR) transmitter and functional user controls. The bobber or lure is provided with a radio receiver that receives signals from the transmitter and in turn supplies a signal to an electrical motor or several motors that turns a series of gears and moves an articulating fin/body to one side or the other. The electric motor supplies the function of moving the bobber or lure either forward or backward by turning an impeller.

According to another aspect, a fishing pole is provided with a radio frequency (RF) radio or infrared (IR) transmitter and functional user controls. The bobber or lure is provided with a radio receiver that receives signals from the transmitter and in turn supplies the signal to the servo and electric motors. The servo motor then supplies the function of steering the bobber or lure by moving linkages attached to a rudder placed at the stern of the bobber or lure. The electric motor supplies the function of moving the bobber or lure either forward or backward by turning a paddle wheel.

According to another aspect, a fishing pole is provided with a radio frequency (RF) radio or infrared (IR) transmitter and functional user controls. The bobber or lure is provided with a radio receiver that receives signals from the transmitter and in turn supplies the signal to actuators and an electric motor. The actuators then supply the function of steering the bobber or lure by moving the rudder placed at the stern of the bobber or lure. The electric motor supplies the function of moving the bobber or lure either forward or backward by turning a paddle wheel.

According to another aspect, a fishing pole is provided with a radio frequency (RF) radio or infrared (IR) transmitter and functional user controls. The bobber or lure is provided with a radio receiver that receives signals from the transmitter and in turn supplies an electrical charge to current-controlled wire that in turn changes length as a charge is applied or removed causing the rudder to move to one side or the other. The electric motor supplies the function of moving the bobber or lure either forward or backward by turning a paddle wheel.

According to another aspect, a fishing pole is provided with a radio frequency (RF) radio or infrared (IR) transmitter and functional user controls. The bobber or lure is provided with a radio receiver that receives signals from the transmitter and in turn supplies a signal to an electrical motor or several motors that turns a series of gears and moves a rudder to one side or the other. The electric motor supplies the function of moving the bobber or lure either forward or backward by turning a paddle wheel.

According to still another aspect, a fishing pole is provided with a radio frequency (RF) radio or infrared (IR) transmitter and functional user controls. The bobber or lure is provided with a radio receiver that receives signals from the transmitter and in turn supplies the signal to the servo and electric motors. The servo motor then supplies the function of steering the bobber or lure by moving an articulating fin/body of the bobber or lure. The electric motor supplies the function of moving the bobber or lure either forward or backward by turning a paddle wheel.

According to another aspect, a fishing pole is provided with a radio frequency (RF) radio or infrared (IR) transmitter and functional user controls. The bobber or lure is provided with a radio receiver that receives signals from the transmitter and in turn supplies the signal to actuators and an electric motor. The actuators then supply the function If steering the bobber or lure by moving an articulating fin/body. The electric motor supplies the function of moving the bobber or lure either forward or backward by turning a paddle wheel.

According to another aspect, a fishing pole is provided with a radio frequency (RF) radio or infrared (IR) transmitter and functional user controls. The bobber or lure is provided with a radio receiver that receives signals from the transmitter and in turn supplies an electrical charge to current-controlled wire that in turn changes length as a charge is applied or removed causing the articulating fin/body to move to one side or the other. The electric motor supplies the function of moving the bobber or lure either forward or backward by turning a paddle wheel.

According to another aspect, a fishing pole is provided with a radio frequency (RF) radio or infrared (IR) transmitter and functional user controls. The bobber or lure is provided with a radio receiver that receives signals from the transmitter and in turn supplies a signal to an electrical motor or several motors that turns a series of gears and moves an articulating fin/body to one side or the other. The electric motor supplies the function of moving the bobber or lure either forward or backward by turning a paddle wheel.

According to another aspect, a fishing pole is provided with a radio frequency (RF) radio or infrared (IR) transmitter and functional user controls. The bobber or lure is provided with a radio receiver that receives signals from the transmitter and in turn supplies the signal to the servo and electric motors. The servo motor then supplies the function of steering the bobber or lure by moving linkages attached to a rudder placed at the stern of the bobber or lure. The electric motor supplies the function of moving the bobber or lures either forward or backward by moving a flipper or articulating tail.

According to another aspect, a fishing pole is provided with a radio frequency (RF) radio or infrared (IR) transmitter and functional user controls. The bobber or lure is provided with a radio receiver that receives signals from the transmitter and in turn supplies the signal to actuators and an electric motor. The actuators then supply the function of steering the bobber or lure by moving the rudder placed at the stern of the bobber or lure. The electric motor supplies the function of moving the bobber or lures either forward or backward by moving a flipper or articulating tail.

According to another aspect, a fishing pole is provided with a radio frequency (RF) radio or infrared (IR) transmitter and functional user controls. The bobber or lure is provided with a radio receiver that receives signals from the transmitter and in turn supplies an electrical charge to current-controlled wire that in turn changes length as a charge is applied or removed causing the rudder to move to one side or the other. The electric motor supplies the function of moving the bobber or lures either forward or backward by moving a flipper or articulating tail.

According to another aspect, a fishing pole is provided with a radio frequency (RF) radio or infrared (IR) transmitter and functional user controls. The bobber or lure is provided with a radio receiver that receives signals from the transmitter and in turn supplies a signal to an electrical motor or several motors that turns a series of gears and moves a rudder to one side or the other. The electric motor supplies the function of moving the bobber or lures either forward or backward by moving a flipper or articulating tail.

According to still another aspect, a fishing pole is provided with a radio frequency (RF) radio or infrared (IR) transmitter and functional user controls. The bobber or lure is provided with a radio receiver that receives signals from the transmitter and in turn supplies the signal to the servo and electric motors. The servo motor then supplies the function of steering the bobber or lure by moving an articulating fin/body of the bobber or lure. The electric motor supplies the function of moving the bobber or lures either forward or backward by moving a flipper or articulating tail.

According to another aspect, a fishing pole is provided with a radio frequency (RF) radio or infrared (IR) transmitter and functional user controls. The bobber or lure is provided with a radio receiver that receives signals from the transmitter and in turn supplies the signal to actuators and an electric motor. The actuators then supply the function of steering the bobber or lure by moving an articulating fin/body. The electric motor supplies the function of moving the bobber or lures either forward or backward by moving a flipper or articulating tail.

According to another aspect, a fishing pole is provided with a radio frequency (RF) radio or infrared (IR) transmitter and functional user controls. The bobber or lure is provided with a radio receiver that receives signals from the transmitter and in turn supplies an electrical charge to current-controlled wire that in turn changes length s a charge is applied or removed causing the articulating fin/body to move to one side or the other. The electric motor supplies the function of moving the bobber or lures either forward or backward by moving a flipper or articulating tail.

According to another aspect, a fishing pole is provided with a radio frequency (RF) radio or infrared (IR) transmitter and functional user controls. The bobber or lure is provided with a radio receiver that receives signals from the transmitter and in turn supplies a signal to an electrical motor or several motors that turns a series of gears and moves and articulating fin/body to one side or the other. The electric motor supplies the function of moving the bobber or lures either forward or backward by moving a flipper or articulating tail.

According to another aspect, any one of the aspects stated above can be used in combination with any of the following types of user controls for transmitting signals to the bobber or lure: (1) Programmable controller chips; (2) infrared (IR); (3) radio frequency (RF); (4) programmable firmware; (5) blue tooth technology; (6) global positioning (GPS); (7) programmable software; (8) a separate hand-held unit that resides outside of the handle such as a transmitter from JR, Sony, Futaba or Hitech using any of the technologies stated in the aspects; (9) free flight control; (10) random configured control.

According to another aspect, any one of the aspects stated above can be used in combination with any of the following types of user controllers: (1) Joysticks; (2) force sensitive resisters (FSR); (3) finger touch pads; (4) push buttons/switches; (5) finger balls; (6) various potentiometers; (7) capacitive switching.

According to another aspect, any one of the aspects stated above can be used in combination with any of the following types of mechanisms for propulsion: (1) Gas motors; (2) solar motors; (3) rubber band motors; (4) steam motors; (5) wind-up motors; (6) CO2 cartridges; (7) air motors; (8) wind; (9) water or air currents; (10) electric motors.

According to another aspect, any one of the aspects stated above can be used in combination with any of the following types of power: (1) Alkaline batteries supplied from various vendors such as Duracell or Energizer; (2) nickel cadmium (NiCad) batteries supplied from vendors such as Sanyo or Panasonic; (3) lithium (LiPoly) batteries supplied from vendors like Kokam; (4) nickel metal hydride (NiMH) batteries supplied from vendors such as Sanyo or Panasonic; (5) solar; (6) water; (7) capacitors.

According to another aspect, any one of the aspects stated above can be used] in combination with any of the following types of drive mechanisms: (1) Direct drive; (2) shaft drive; (3) flex shaft drive; (4) coupling drive; (5) universal joint drive; (6) gear drive.

According to another aspect, any one of the aspects stated above can be used in combination with any of the following propulsion methods: (1) Float/water current; (2) propeller; (3) impeller; (4) jet drive—water; (5) jet drive—air; (6) flipper; (7) articulating fin/body; (8) paddle wheel; (9) wind.

According to another aspect, any one of the aspects stated above can be used in combination with any of the following locations for the propulsion methods: (1) The bow; (2) the stern; (3) the port; (4) the starboard; (5) the top; (6) the keel; (7) somewhere in between any of the above points.

According to another aspect, any one of the aspects stated above can be used in combination with any of the following steering mechanisms: (1) Rudder/elevator; (2) articulating fin/body; (3) articulating jet drive; (4) articulating motor drive; (5) multiple pulsating motors; (6) air blasts; (7) water brakes; (8) air brakes; (9) electro-magnets; (10) capacitance switching.

According to another aspect, any one of the aspects stated above can be used in combination with any of the following handles: (1) Various casting handle; (2) various spinning handle; (3) various articulating spinning handle; (4) various fly rod handle.

### BRIEF DESCRIPTION OF THE DRAWINGS

Preferred embodiments of the invention are described below with reference to the following accompanying drawings.

FIG. 1 illustrates one fishing environment where an angler is retrieving a fish that has been caught using a remotely-controlled fishing lure and transmitting control device according to one aspect of the present invention.

FIG. 2 illustrates a second fishing environment where an angler is seated in a row boat and is retrieving a fish that has been caught using a remotely-controlled bobber and transmitting control device according to another aspect of the present invention.

FIG. 3 illustrates a third fishing environment where a handicapped angler is using a remotely-controlled lure and transmitting control device to direct movement of the lure to desired locations according to another aspect of the present invention.

FIG. 4 is an enlarged simplified perspective view of the remotely-controlled lure depicted in FIG. 1.

FIG. 5 is an enlarged simplified perspective view illustrating the remotely-controlled bobber of FIG. 2.

FIG. 6 is a perspective view of the remotely-controlled lure of FIG. 3.

FIG. 7 is a vertical centerline sectional view taken through the remotely-controlled lure of FIG. 6.

FIG. 8 illustrates a simplified functional block diagram for transmitting circuitry within a transmitting control device such as the devices depicted in FIGS. 10 and 11.

FIG. 9 illustrates a functional block diagram for a receiver-controlled device such as the receiver depicted in the remotely-controlled lure of FIG. 7.

FIG. 10 illustrates a fishing pole with a handle component that includes an integrated, or built-in transmitter control device with a joy stick input device and a push button on/off switch.

FIG. 11 is a sectional view of the handle component of FIG. 10 taken along line 11-11 of FIG. 10.

FIG. 12 is a simplified perspective view of an alternative transmitting control device utilizing the control circuitry of FIG. 8 according to another aspect of the invention.

FIG. 13 is a simplified perspective view of a second alternative transmitting control device over that depicted in FIGS. 10 and 12.

FIG. 14 is a simplified perspective view of a first type of input device used on the transmitting control device of FIGS. 10, 12 and 13.

FIG. 15 is a simplified perspective view of an alternative input device for use on a transmitting control device over that depicted in FIG. 14.

FIG. 16 is a simplified perspective view of a second alternative input device for use on a transmitting control device over that depicted in FIG. 14.

FIG. 17 is a simplified perspective view of a third alternative input device for use on a transmitting control device over that depicted in FIG. 14.

FIG. 18 is a simplified perspective view of a fourth alternative input device for use on a transmitting control device over that depicted in FIG. 14.

FIG. 19 is a simplified perspective view of a fourth alternatively constructed remote-controlled and self-propelled lure.

FIG. 20 is a simplified perspective view of a fifth alternatively constructed remote-controlled and self-propelled lure.

FIG. 21 is a simplified perspective view of a sixth alternatively constructed remote-controlled and self-propelled lure.

FIG. 22 is a simplified perspective view of a seventh alternatively constructed remote-controlled and self-propelled lure.

FIG. 23 is a simplified perspective view of a eighth alternatively constructed remote-controlled and self-propelled lure.

FIG. 24 is a simplified perspective view of a ninth alternatively constructed remote-controlled and self-propelled lure.

FIG. 25 is a simplified perspective view of a tenth alternatively constructed remote-controlled and self-propelled lure.

FIG. 26 is a simplified perspective view of an eleventh alternatively constructed remote-controlled and self-propelled lure.

FIG. 27 is a simplified breakaway perspective view illustrating one rudder assembly utilized with the remote-controlled, self-propelled lure of FIGS. 5-7, and 19.

FIG. 28 is a simplified side view depicting one construction for a unitary drive module for use in a self-propelled lure or bobber.

FIG. 29 is a simplified side view depicting a first alternative construction for a unitary drive module for use in a self-propelled lure or bobber.

FIG. 30 is a simplified side view depicting a second alternative construction for a unitary drive module for use in a self-propelled lure or bobber.

FIG. 31 is a simplified side view depicting a third alternative construction for a unitary drive module for use in a self-propelled lure or bobber.

FIG. 32 is a simplified side view depicting a fourth alternative construction for a unitary drive module for use in a self-propelled lure or bobber.

FIG. 33 is a simplified side view illustrating a first propeller configuration for a self-propelled fishing apparatus, such as a self-propelled bobber or self-propelled lure.

FIG. 34 is a first alternative propeller configuration over that depicted in FIG. 33.

FIG. 35 is a second alternative propeller configuration over that depicted in FIG. 33.

FIG. 36 is a third alternative propeller configuration over that depicted in FIG. 33.

FIG. 37 is a fourth alternative propeller configuration over that depicted in FIG. 33.

FIG. 38 is a simplified, partial and perspective view for an electric motor as utilized in the lure of FIG. 7.

FIG. 39 is a simplified, partial and perspective view illustrating an alternative wind-up motor for driving a self-propelled fishing apparatus, such as a self-propelled bobber or self-propelled lure.

FIG. 40 is a simplified, partial and perspective view illustrating a second alternative wind-up motor for driving a self-propelled fishing apparatus, such as a self-propelled bobber or self-propelled lure.

FIG. 41 is a simplified plan view illustrating movement of a remotely-controlled lure as it is being towed behind a trolling fishing boat.

FIG. 42 is a simplified plan view showing remote-controlled positioning of a self-propelled bobber which has been positioned using a remote control and self-propelled motor without actually casting the bobber between a first position and a second position in order to place the fishing line into a desirable location on a body of water.

FIG. 43 is a simplified plan view showing repositioning of the bobber after the bobber has been cast to place the bobber and fishing line into desired locations on a body of water.

FIG. 44 is a simplified vertical view illustrating an angler in a fishing boat using a remote-controlled and self-propelled fishing lure that is capable of being maneuvered and repositioned at various locations and depths within the body of water.

FIG. 45 shows a typical side view of a remote-controlled and self-propelled bobber attached to a fishing pole.

FIG. 46 shows a typical side view of a remote-controlled and self-propelled lure attached to a fishing pole.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to preferred embodiments of Applicants' invention directed to transmitting control devices that are incorporated within a fishing pole for remote-controlling a navigable fishing apparatus such as a self-propelled fishing lure or bobber. While the invention is described by way of preferred embodiments, it is understood that the description is not intended to limit the invention to such embodiments, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

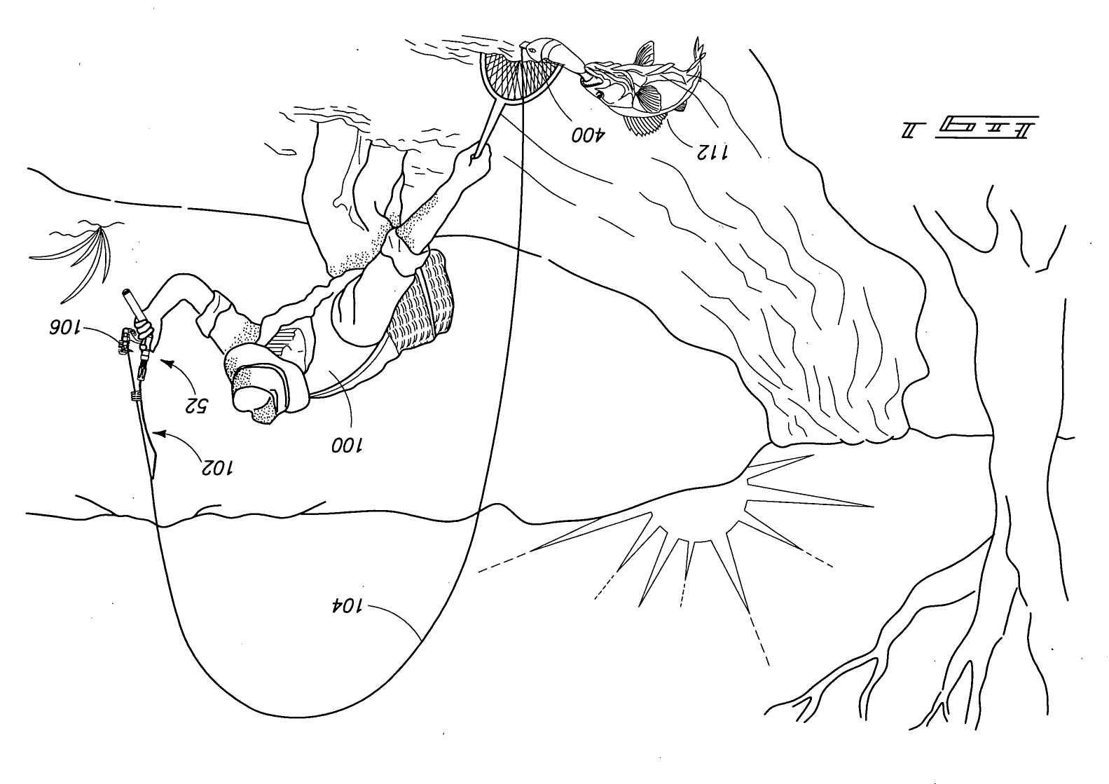

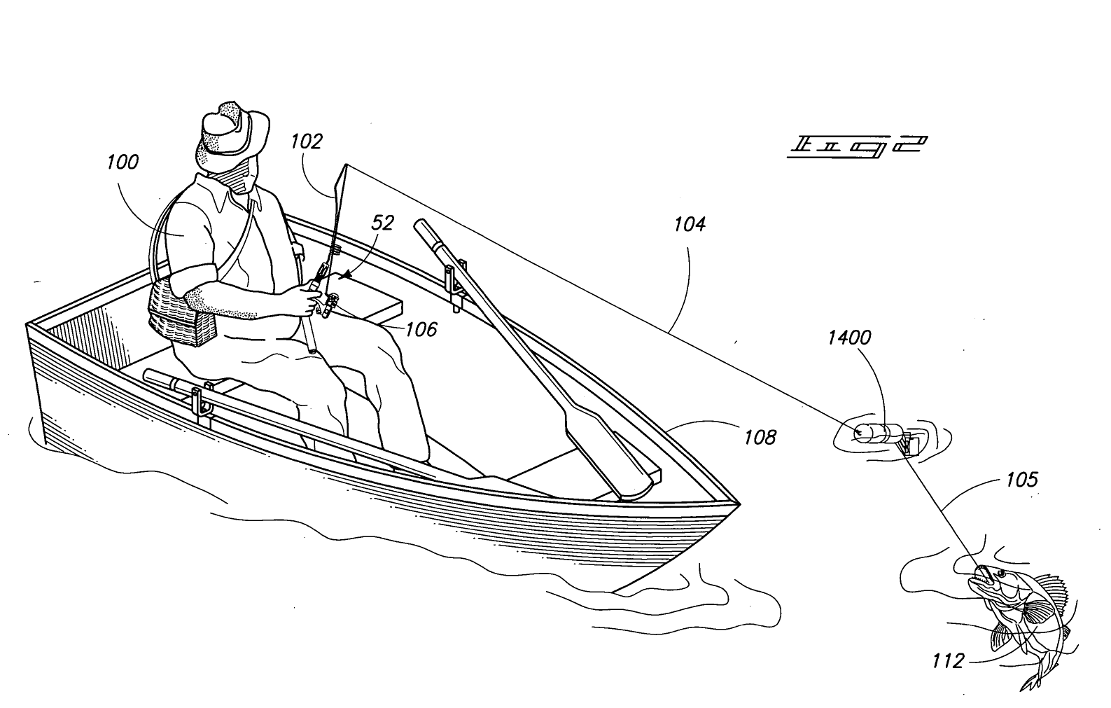

There are a variety of techniques by which anglers can fish. One type of fishing is performed as shown in FIG. 1 in which an angler 100 stands along the bank of a river or other body of water (or even stands in the water) and casts a lure 400 from a fishing pole 102, then retrieves the lure and/or a fish. The lure 400 is attached to the pole by a fishing line 104 using an eyelet 490 (shown in FIGS. 4 and 5). Optionally, a bobber 1400 (see FIG. 2) can be used. A reel 106 is attached to the fishing pole 102, and used to reel in line on which the bobber 1400 or lure 400 is affixed. In an alternative fishing technique shown in FIG. 2, the angler 100 is positioned in a rowboat 108. The boat 108 is preferably anchored or drifting through the water. In another alternative fishing technique shown in FIG. 3, the angler 100 is handicapped and is sitting in a wheelchair 110 on a dock 109. In this case, a self-propelled underwater lure 2400 is attached to line 104.

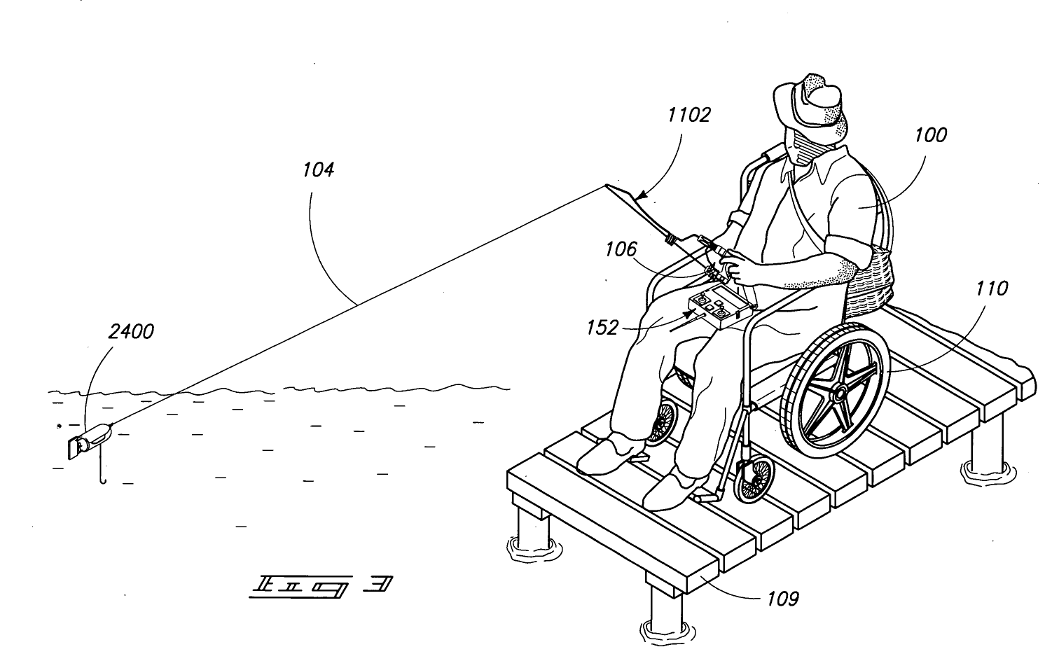

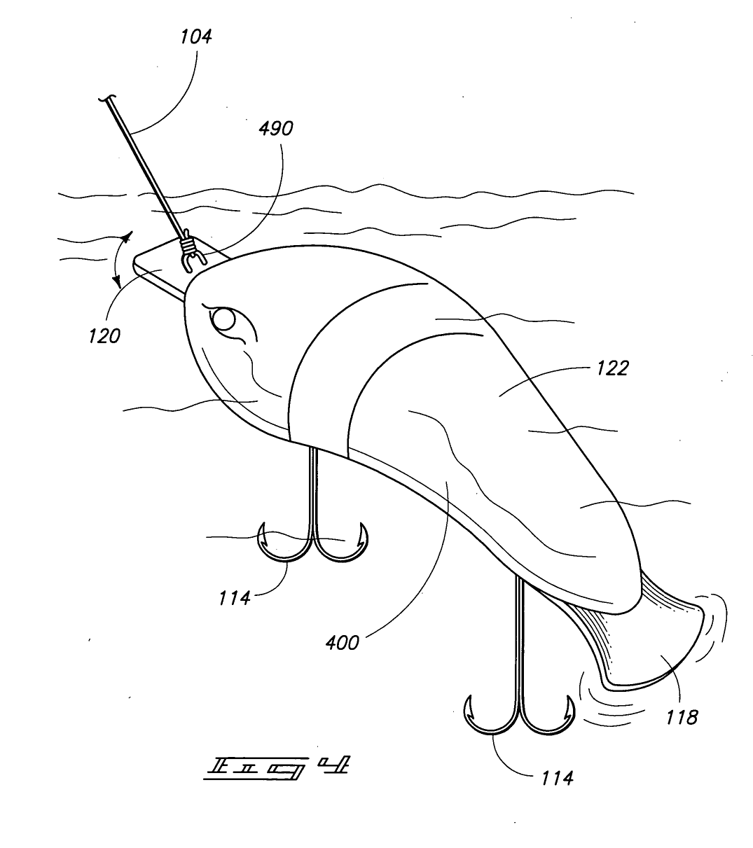

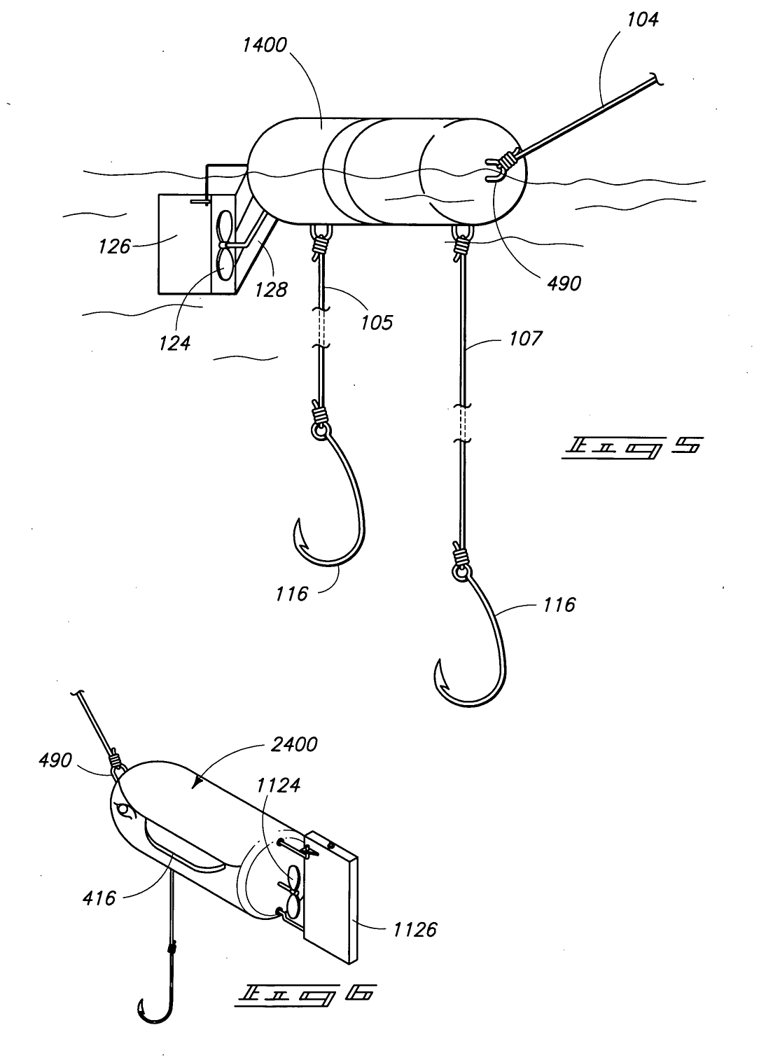

FIGS. 4-6 show the lure 400, bobber 1400, and lure 240, respectively, in their functional positions in the water. From this position the angler 100 can activate a remote system or transmitting control device 52 located in the handle 111 (of FIGS. 10 and 11) by pushing forward on a joystick 132 (also see FIG. 12). An input signal is sent to a receiver 142 (of FIG. 9) which relays the signal and with the battery 146 starts the motor 148 that turns the propeller 1124 allowing the lure 400 (or bobber) to move forward. Respectively, if angler 100 pulls the joystick 132 backward, the motor 148 then reverses the direction of the propeller 1124 and the lure 400 moves backwards. If angler 100 wants to turn the lure 400 left or right, he can do so by moving the joystick 132 in any direction he wants, left or right, while concurrently moving the joystick 132 either forward or backward. The transmitter 134 sends out the signal to receiver 142 (of FIG. 9) and with the battery 146 starts the motor 148 and turns the propeller 1124 and concurrently a signal is sent to a servo motor 144 that rotates a servo arm 150 in the direction input by the user, which in turn turns a rudder 1126 (of FIG. 7) left or right. Anti-torque fins 416 (of FIG. 6) can also be provided as required to prevent the unwanted counter-rotation of lure 400 due to the rotating propeller 1124.

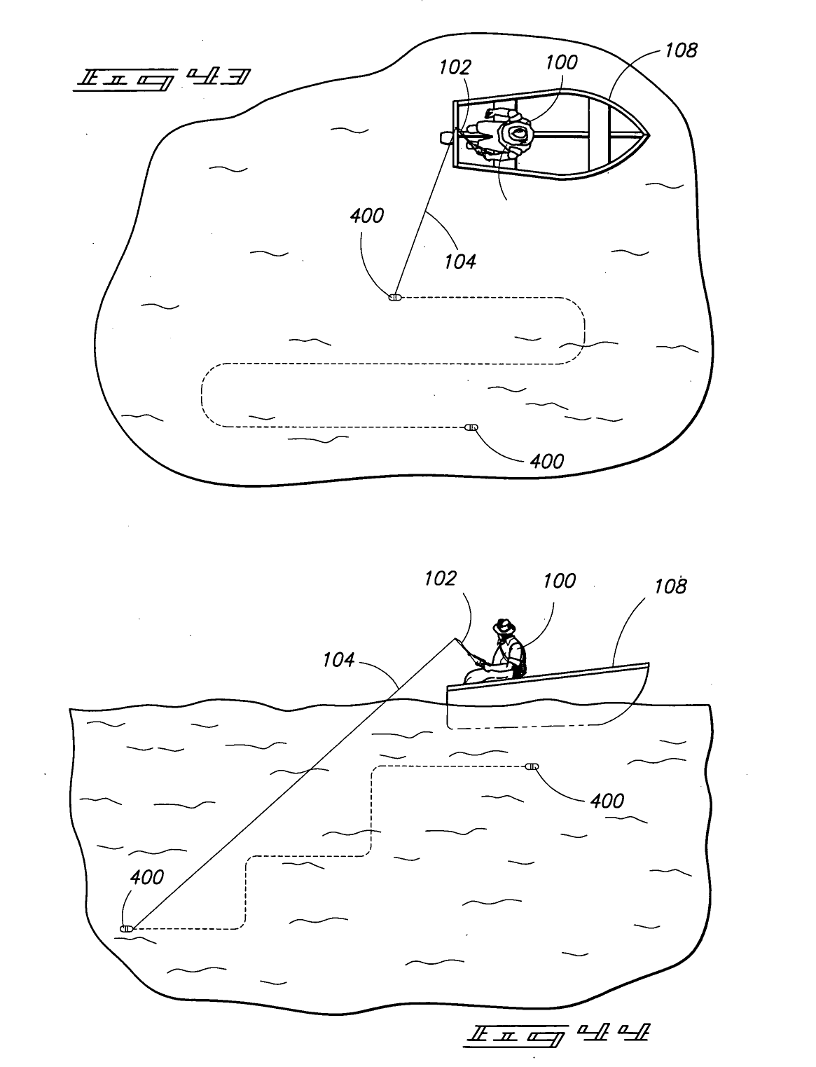

Lure 400 is navigated into any position chosen by angler 100 by engaging the propeller and turning the rudder to selected positions. The lure 400 can be cast into the water or it can be placed into the water next to the angler 100. Subsequently, an angler 100 can control the lure 400 from either starting point. The angler 100 can manipulate the lure 400 into various directions to navigate around obstacles and position lure 400 into areas that are hard to reach by casting a line. Alternatively, an angler 100 can continually work a lure 400 along a path mimicking a swimming fish as shown in FIGS. 41-44. The ability to maneuver lure 400 minimizes casts and allows the angler 100 to access multiple hard-to-reach locations as well as allowing the lure 400 to be in the water for a longer given time. This allows for a greater potential in catching fish. Alternatively, a bobber 1400 can be navigated into a desired position using the same techniques.

FIG. 4 illustrates one construction for a navigable fishing apparatus comprising a remote-controlled and self-propelled fishing lure 400. Lure 400 includes receiving circuitry contained therein, such as receiving circuitry 140 as depicted in FIG. 9. However, lure 400 includes an optional oscillating fin 118 that is used to propel lure 400 in a forward direction. Additionally, a positionable dive plane 120 is provided at a forward end of lure 400 for adjusting depth of lure 400 as lure 400 is propelled forward via oscillation of fin 118. A pair of treble hooks 114 is also provided on body 122 of lure 400 to enable engagement of a fish onto line 104. An eyelet 490 is provided on dive plane 120 for tying lure 400 onto an end of fishing line 104 using any of a number of presently known fishing knots.

FIG. 5 illustrates an alternatively constructed navigable fishing apparatus comprising a remotely-controlled and self-propelled fishing bobber 1400. Bobber 1400 was previously depicted in FIG. 2 and includes receiving circuitry 140 as illustrated in FIG. 9. A pair of leader lines 105 and 107 are each affixed beneath bobber 1400 for attaching snell hooks 116, respectively. Hooks 116 typically receive live bait, such as a worm. Self-propelled bobber 1400 includes a pivotally positionable rudder 126 and a propeller 124. Preferably, propeller 124 is driven via a flex shaft. Optionally, propeller 124 is driven via a shaft drive that has a universal drive joint between two rigid cylindrical shafts. Bobber 1400 is driven forward via rotation of propeller 124 and is positioned in a horizontal plane by varying the positioning of rudder 126 while driving propeller 124. Rotatably positioning of rudder 126 to desired positions while driving propeller 124 enables the movement of bobber 1400 in a forward direction. Receiving circuitry within bobber 1400 receives input commands from a user via a transmitting control device that is integrated within the handle of a fishing pole (see FIGS. 10 and 11). Receiving circuitry within bobber 1400 receives commands for activating and driving propeller 124 as well as rotatably positioning rudder 126 to locations that are desired by a user and which are dictated by input signals received via a user of a transmitting control device.

FIG. 6 illustrates a second alternative construction for a navigable fishing apparatus comprising another construction for a remotely-controlled and self-propelled fishing lure 2400. Lure 2400 includes a pair of anti-torque fins 416 that are provided on opposite sides of lure 2400 to prevent rotation of lure 2400 as a result of rotation of propeller 1124. Rudder (or fin) 1126 is similarly rotatably positioned in response to user input commands that are delivered to lure 2400 via a transmitting control device within a fishing pole handle. Likewise, propeller 1124 is driven in rotation in response to user input commands that are received from a transmitting control device to lure 2400 using control circuitry in the form of receiving circuitry 140 (of FIG. 9).

FIG. 7 illustrates construction of the internal components for the remotely-controlled and self-propelled fishing lure 2400 of FIG. 6. It is understood that lure 400 of FIG. 4 and bobber 1400 of FIG. 5 are constructed with similar components using substantially identical receiving circuitry to drive a propeller (or a fin) and to position a rudder (or fin).

Although not shown herein, it is further understood that an additional servo motor can be provided in the device of FIG. 7 in order to position a pair of rotatable fins, similar to anti-torque fins 416 (see FIG. 6). However, such fins are rotatably positionable in order to function as dive planes that enable a user to navigate lure 2400 to various depths by changing the angle of attack on fins 416 while driving lure 2400 in a forward (or reverse) direction via rotation (or counter-rotation) of propeller 1124.

As shown in FIG. 7, self-propelled lure 2400 includes a direct current (DC) electric motor 148 that is provided within a watertight and sealed interior of lure 2400. An exit shaft on motor 148 extends through a localized seal in a housing for lure 2400 in order to drive propeller 1124 in rotation outside of the housing of lure 2400 for driving lure 2400 in a forward direction (and, optionally, a reverse direction). A servo motor 144 is used to reposition a servo arm in various rotatable positions to rotate a rudder 1126 to desired rotary positions to change direction of lure 2400 when viewed in plan view. A receiver 142 comprises receiving circuitry 140 (see FIG. 10) for directing operation of motor 148 and servo motor 144. A battery 136 supplies power to control and receiving circuitry within receiver 142, as well as to servo motor 144 and drive motor 148.

FIG. 8 illustrates transmitting circuitry 130 that is incorporated within a handle component for a handle on a fishing rod, as depicted below with reference to FIGS. 10 and 11. More particularly, a logic function block diagram is illustrated in FIG. 8 to show how a user provides input signals via a joystick 132 to navigate a fishing apparatus such as a self-propelled fishing lure or fishing bobber into desired positions within a body of water. For example, inputs from joystick 132 are sent to transmitter 134 comprising transmitting circuitry. Transmitting circuitry includes an antenna that transmits wireless signal information to a receiver 142 (see FIG. 9) which has similar receiving circuitry and a receiving antenna therein. A battery 136 supplies power to transmitting circuitry 130. An on/off switch 138 enables a user to turn power supply on and off from battery 136 for transmitting circuitry 130.

FIG. 9 illustrates a logic function block diagram for a remotely-controlled and self-propelled lure. Alternatively, a remotely-controlled and self-propelled bobber can have similar circuitry configured to move either a propeller or fin and one or more rudders or dive planes. As shown in FIG. 9, a receiver 142 provides receiving circuitry 140 that receives a signal that has been transmitted from transmitting circuitry 130 (of FIG. 8). In this manner, a user can provide input signals that are received via receiver 142 and which are used to direct operation of a servo motor 144 and a drive motor 148 in order to properly position a rudder 1126 and propeller 1124, respectively, to a user-desired position. In this manner, a user can navigate a self-propelled lure (or bobber) to desired positions within a body of water by sending desired input signals via receiver 142 to servo motor 144 and drive motor 148. A supply of power is provided via a direct current (DC) battery 146 to receiver 142, servo motor 144, and drive motor 148. Servo motor 144 pivotally positions a servo arm 150 in order to move a rudder to a left position, a right position, or an intermediate position. Likewise, drive motor 144 can be configured to drive a propeller 1124 in either a forward direction or a reverse direction. Furthermore, drive motor 148 can be turned off in order to stop motion of propeller 1124 so as to position a lure in a desired, stationary position within a body of water. It is further understood that dive planes can be added to the circuitry of FIG. 9 via the addition of another servo motor(s) and servo arm(s) in order to rotatably position dive planes in a manner that can be used to adjust the depth of a lure as it is being propelled through a body of water via rotation of propeller 1124.

FIG. 10 is a side elevational view of a fishing pole 102 having a fishing rod 103 and a handle 404 constructed according to techniques disclosed in pending U.S. Patent application Ser. Nos. 10/607,285 entitled “Fishing Rod” filed Jun. 25, 2003, and 10/655,792 entitled “Fishing Rod Connector, and Connector Assemblies for Fishing Poles” filed Sep. 4, 2003, both of which are herein incorporated by reference. Additionally, handle assembly 404 of FIG. 11 includes a handle component 111 that includes a hollow chamber in which transmitting circuitry 130 (see FIG. 8) is provided therein. More particularly, transmitting circuitry 130 includes a joystick 132 that extends laterally from handle component 111 and an on/off switch 138 that extends downwardly from handle component 111. Transmitting circuitry 130 includes a transmitter 134 having a transmitting antenna extending therefrom. According to one construction, the transmitting antenna can be encased within handle component 111. According to another construction, the antenna of transmitter 134 can extend externally of handle component 111 via a sealed aperture provided in handle component 111. Additionally, a direct current (DC) battery 136 is also provided within handle component 111.

More particularly, handle component 111 comprises a rigid aluminum tube 141 that is surrounded by a cork cover 143. A plug 145 is provided in a distal end of tube 144 for threadingly receiving an end cap 147 that retains one or more counter weights 149 along such distal end of handle component 111.

Weights 149 can be added or removed from handle component 111 in order to balance a fishing pole pursuant to techniques that were taught in U.S. patent application Ser. No. 10/679,224 entitled “Fishing Poles, Counter-Balancing Apparatus for Fishing Poles and Fishing Pole Handles, and Methods for Balancing Fishing Poles” and filed Oct. 2, 2003, herein incorporated by reference.

According to one construction, transmitter 134 includes transmitting circuitry 130 that is miniaturized in order to fit within tube 141. Additionally, seals can be added to weights 149 and end cap 147 in order to seal the interior of tube 141 so as to protect electronic components encased therein. Likewise, joystick 132 and switch 138 can be provided with O-ring seals in order to seal joystick 132 and switch 138 with tube 141.

One suitable construction for transmitting circuitry 130 comprises a 2.4 GHz ISM band transceiver, Model No. MC13192, sold by Freescale Semiconductor, Inc., 6501 William Cannon Drive West, Austin, Tex. 78735. Freescale Semiconductor, Inc. was previously referred to as Motorola's Semiconductor Products Sector (SPS) of Motorola, Inc. Such exemplary transmitting circuitry comprises transmitting and receiving circuitry configured in a miniature chip set that uses infrared (IR) technology and an accelerometer to transmit signals to a similar and compatible receiver. Such a transceiver supports IEEE 802.15.4 wireless standard supporting star and mesh networking. Such transceiver can also be used with a microcontroller (MCU) and accompanying software in order to provide a cost-effective and miniature solution for short-range data links and networks. Interfacing with an MCU can be accomplished by using a four-wire serial peripheral interface (SPI) connection, which can enable the use of a variety of processors. Accordingly, software and processors can be scaled in order to fit applications ranging from a simple point-to-point system, all the way through a complete networking solution.

Optionally, any of a number of known transmitting and receiving circuitries can be utilized for the implementations depicted in FIGS. 8 and 9. One suitable alternative construction for transmitter 130 of FIG. 11 comprises a Hitech Laser 4 transmitter available from Hitech RCD USA, Inc., of 12115 Paine St., Poway, Calif. 92064. For example, a Cirrus Micro Joule FM receiver can be utilized for receiving circuitry. With respect to power supplies, respective batteries can comprise any DC batteries such as Triple A-type lithium rechargeable batteries or any other store-purchased small battery, such as a watch battery. Furthermore, one exemplary servo motor comprises a Cirrus CS-3 Micro Joule servo motor.

FIG. 12 illustrates a first alternative construction for a transmitter over that depicted in FIGS. 10-11. Likewise, FIG. 13 illustrates a second alternative construction for a transmitter over that depicted in FIGS. 10-11.

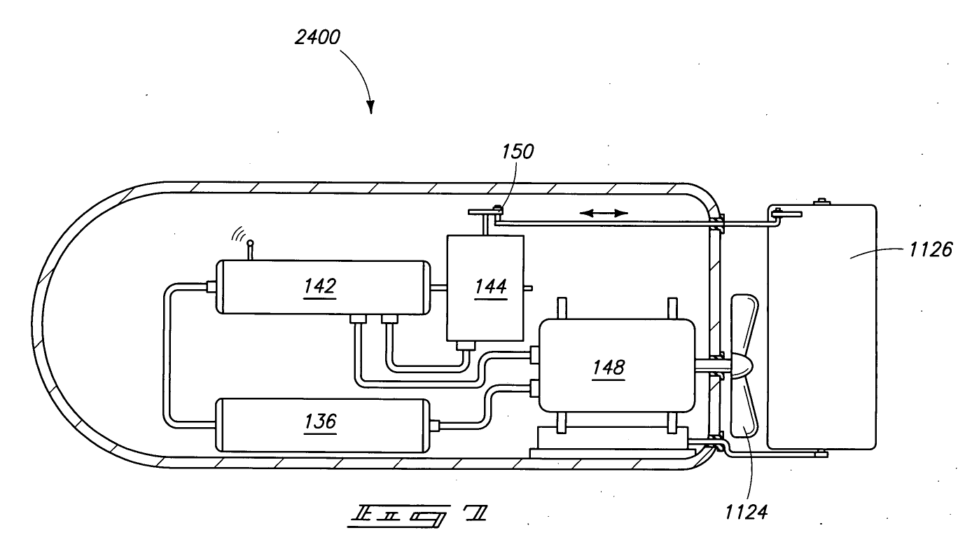

FIG. 14 illustrates construction of joystick 32 including a pivotable X and Y axis base component 404 for directing X and Y axis positioning when navigating a navigable fishing apparatus such as a fishing lure or a fishing bobber. X axis motion will impart left and right positioning for a rudder, whereas Y axis positioning of joystick 132 will impart forward and reverse propulsion to a propeller.

FIG. 15 illustrates an optional construction for a user input device for a fishing pole transmitter comprising a finger touch pad 1132.

FIG. 16 illustrates a second alternatively constructed input device comprising a finger ball input device 2132.

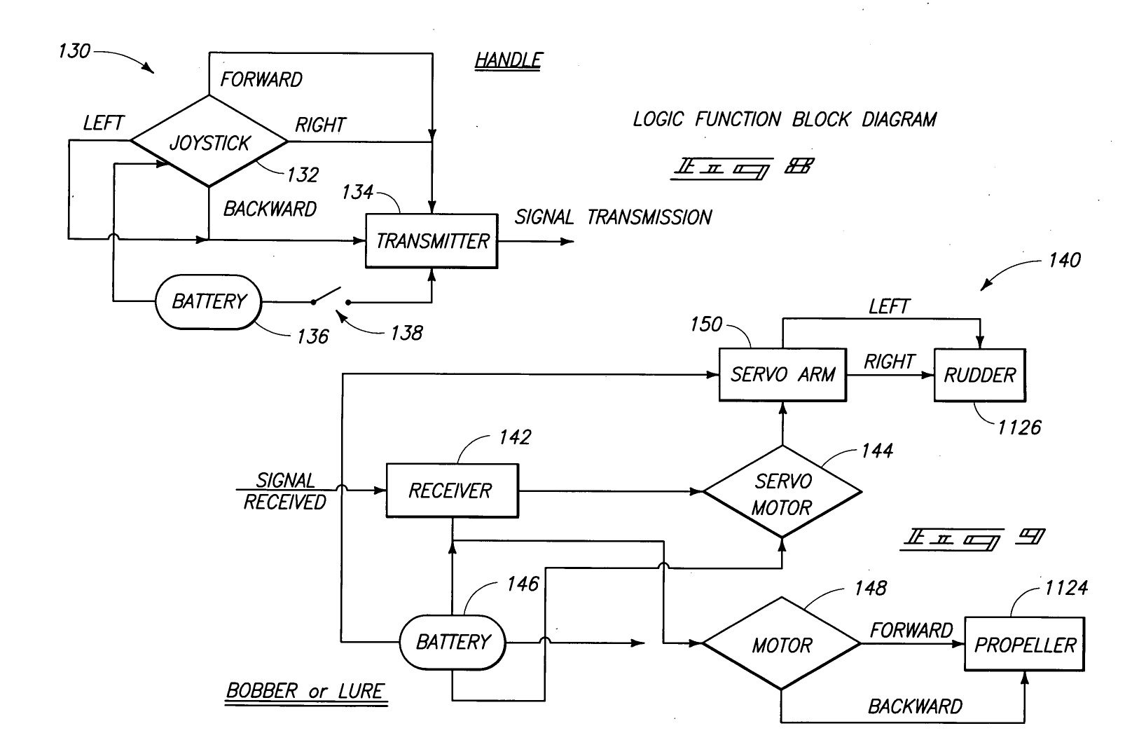

FIG. 17 illustrates one construction for an on/off switch 3132 as implemented in the fishing pole of FIGS. 9-10 and further illustrating another construction for a user input device.

FIG. 18 illustrates yet another alternative construction for a user input device comprising a linear potentiometer switch 4132.

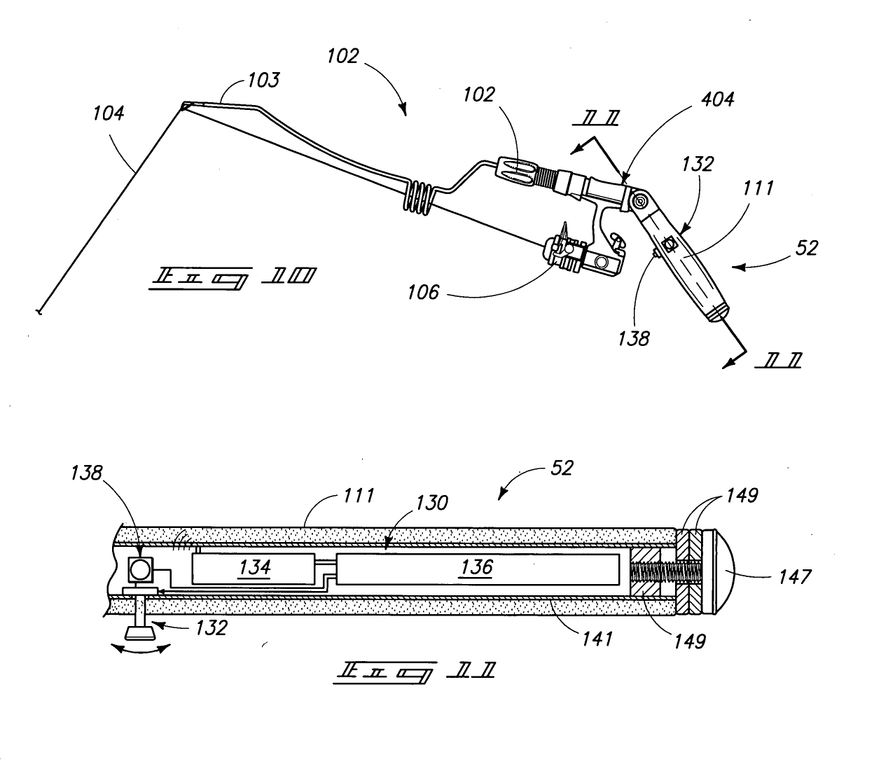

FIG. 19 illustrates a fourth embodiment lure 3400 having an impeller 2124 comprising a circumferential array of propeller blades and a rudder 414.

FIG. 20 illustrates a fifth alternatively constructed remote-controlled and self-propelled lure 4400 having a flipper that is moved laterally in order to propel lure 4400 in a forward direction.

FIG. 21 is a sixth alternatively constructed lure 5400 comprising a jet drive 420 that is configured to propel lure 5400 in a forward direction.

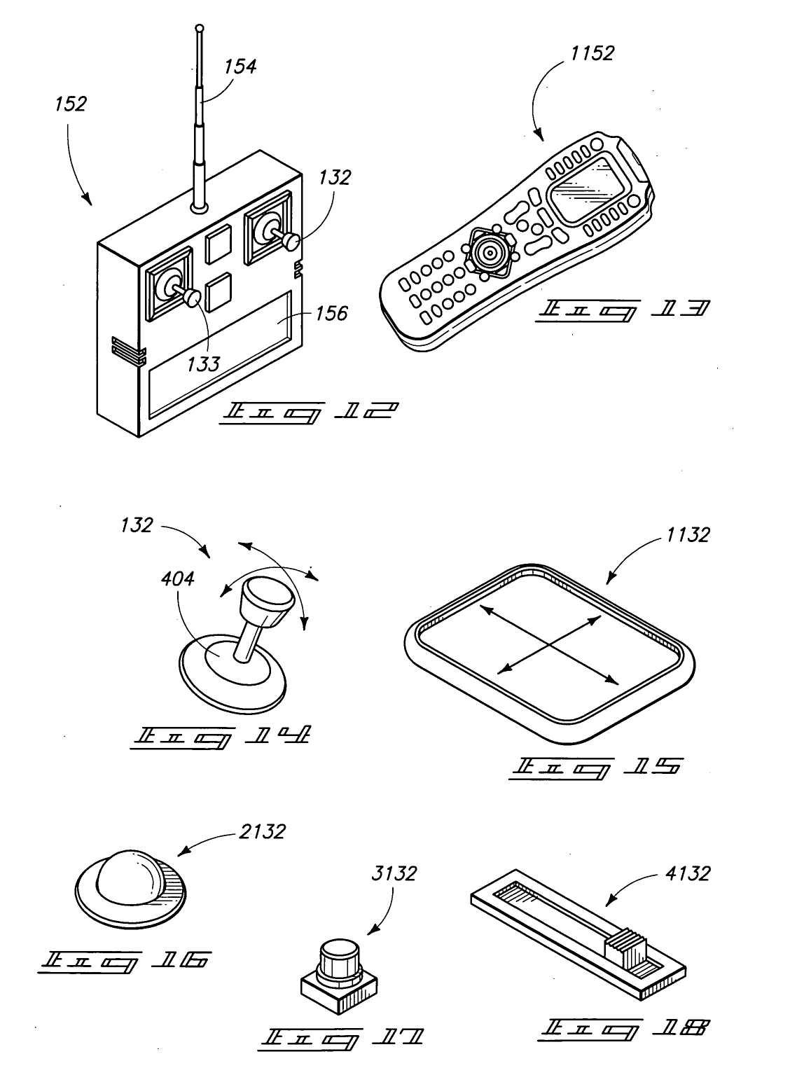

FIG. 22 illustrates a seventh alternatively constructed remote-controlled and self-propelled lure having a paddle wheel 422 carried by a body 400 of lure 6400.

FIG. 23 is an eighth alternatively constructed lure 9400 having an articulating jet drive with an articulating nozzle.

FIG. 24 is a ninth alternatively constructed lure 8400 that has a water break, or flap, underneath each of a pair of stationary wings that can be extended and retracted to increase water drag on lure 8400 to break motion of lure 8400.

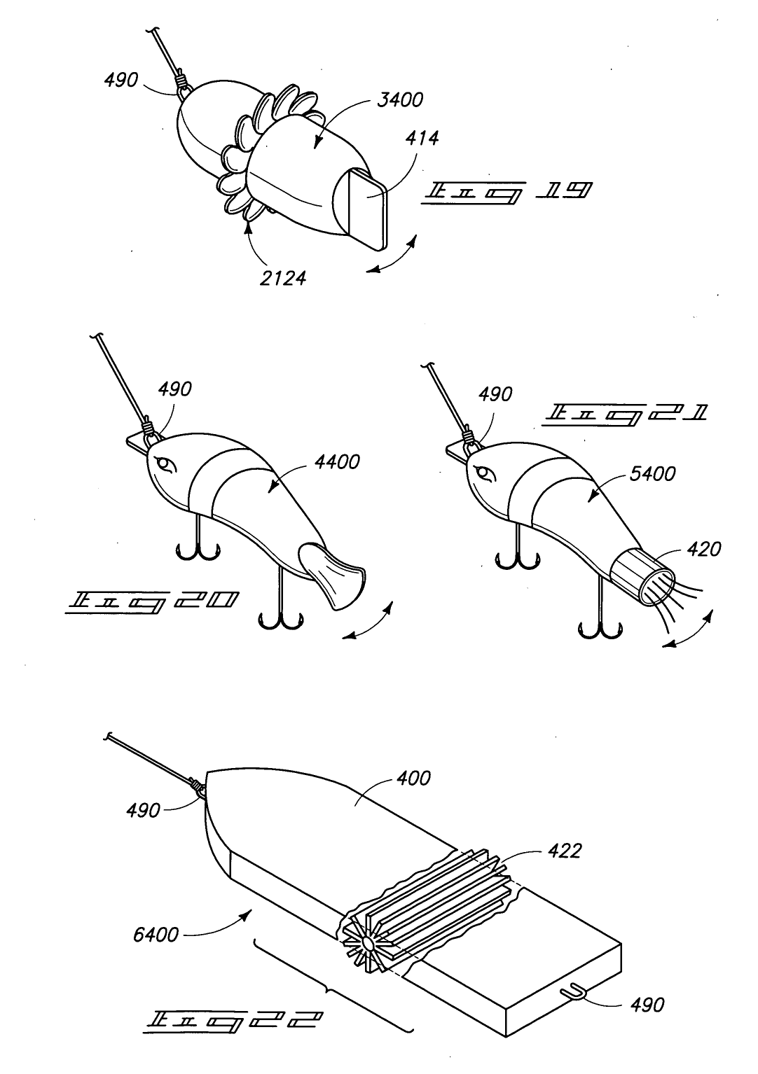

FIG. 25 illustrates a tenth alternatively constructed lure 9400 having an articulating body that terminates in a propeller. By articulating the body segment, the propeller can be pointed in order to change the propulsion direction of lure 9400.

FIG. 26 illustrates the utilization of multiple motor pods, each having a propeller thereon for driving a fishing apparatus such as a self-propelled lure or bobber.

FIG. 27 illustrates one construction for a rudder usable with any of the fishing apparatus, such as lures or bobbers disclosed herein.

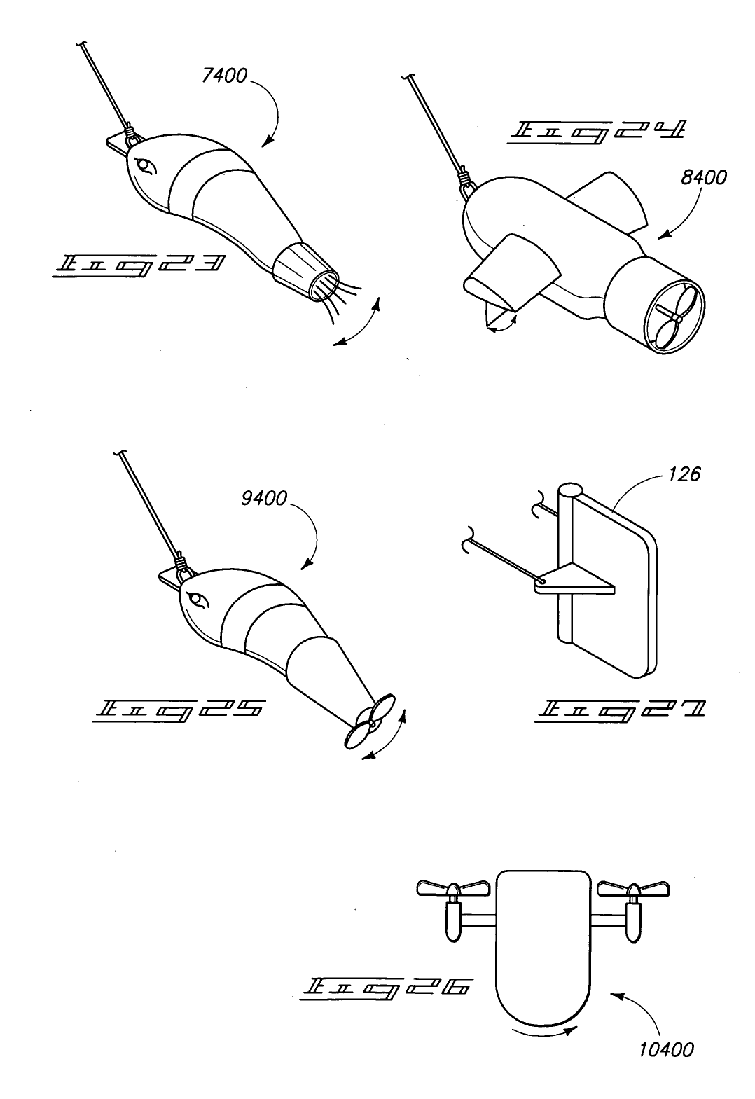

FIGS. 28-32 illustrate various constructions for a unitary drive module that has an electric drive motor and a propeller therein.

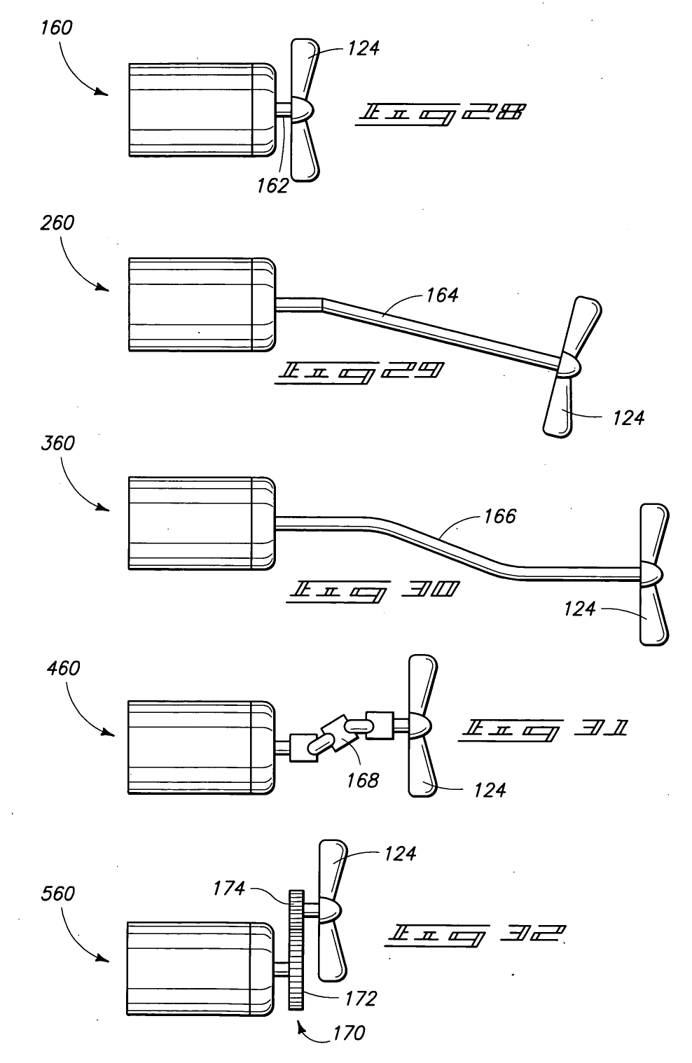

For example, FIG. 28 illustrates a drive module 160 having a motor shaft 162 on which a propeller is directly driven by motor shaft 162 rearwardly of the motor on the module 160. FIG. 29 illustrates a drive module having a draft shaft 164 that is flexibly coupled to the motor shaft to provide an angular drive for driving a propeller 124 at an angle. FIG. 30 illustrates another construction for a module 360 having a flexible drive shaft 166 comprising a cylindrical spring that is provided within a tube in which it is rotated to drive propeller 124. FIG. 31 illustrates a third alternative construction for a drive module 460 having coupling/universal joints within a drive shaft 168 for driving a propeller 124. FIG. 32 illustrates a fourth alternative construction drive module 560 having a gear drive assembly 170 including a pair of gears 172 and 174 configured to drive a propeller 124 at the rear end of a motor.

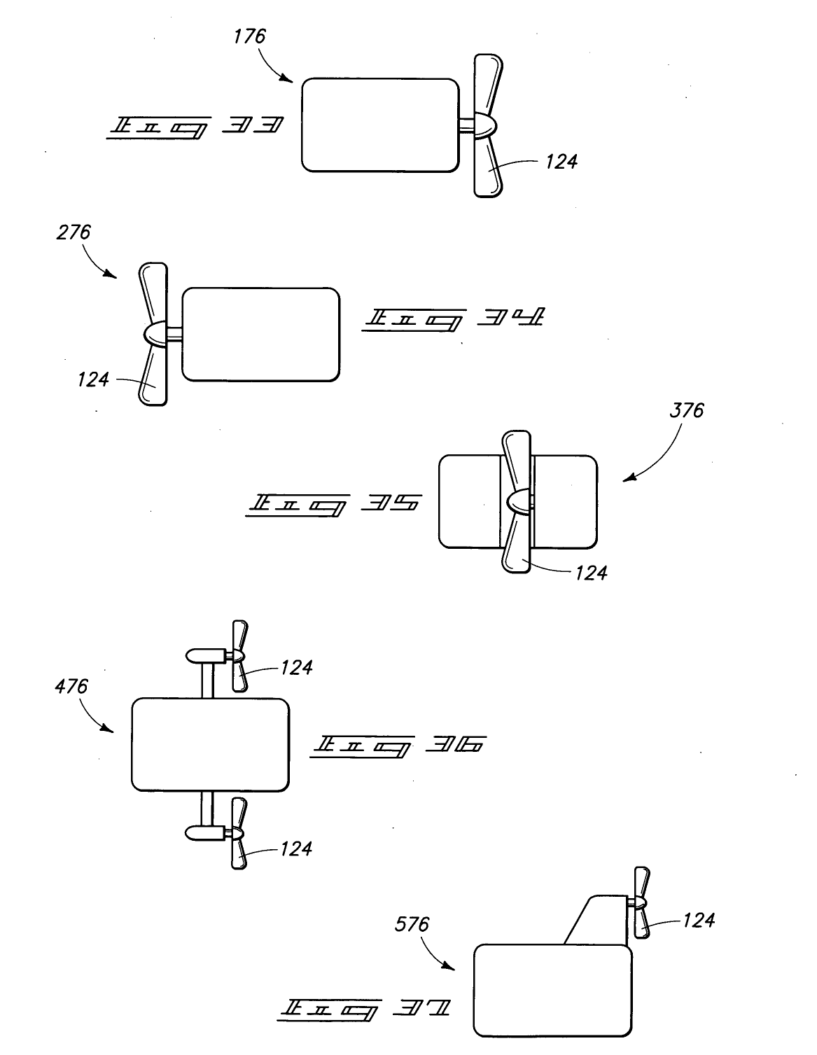

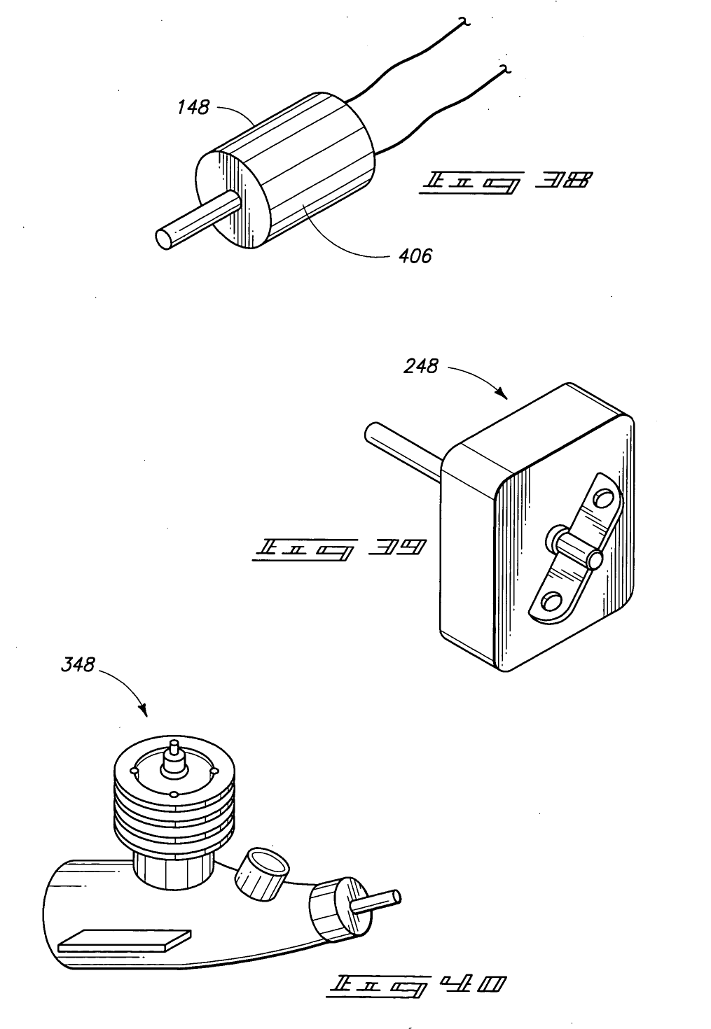

FIGS. 33-37 illustrate various propeller configurations for a fishing apparatus. For example, FIG. 33 shows a first propeller configuration 176 having a propeller 124 mounted on the rear of a fishing apparatus. FIG. 34 shows a second configuration 276 with a propeller 124 at the forward end of a fishing apparatus (bobber or lure). FIG. 35 shows a third configuration 376 with a propeller 124 provided in an intermediate cavity within a fishing apparatus. FIG. 36 shows a configuration 476 with a pair of side mounted propellers 124 on a fishing apparatus. FIG. 37 illustrates a fourth alternative configuration 576 having a top mounted propeller.

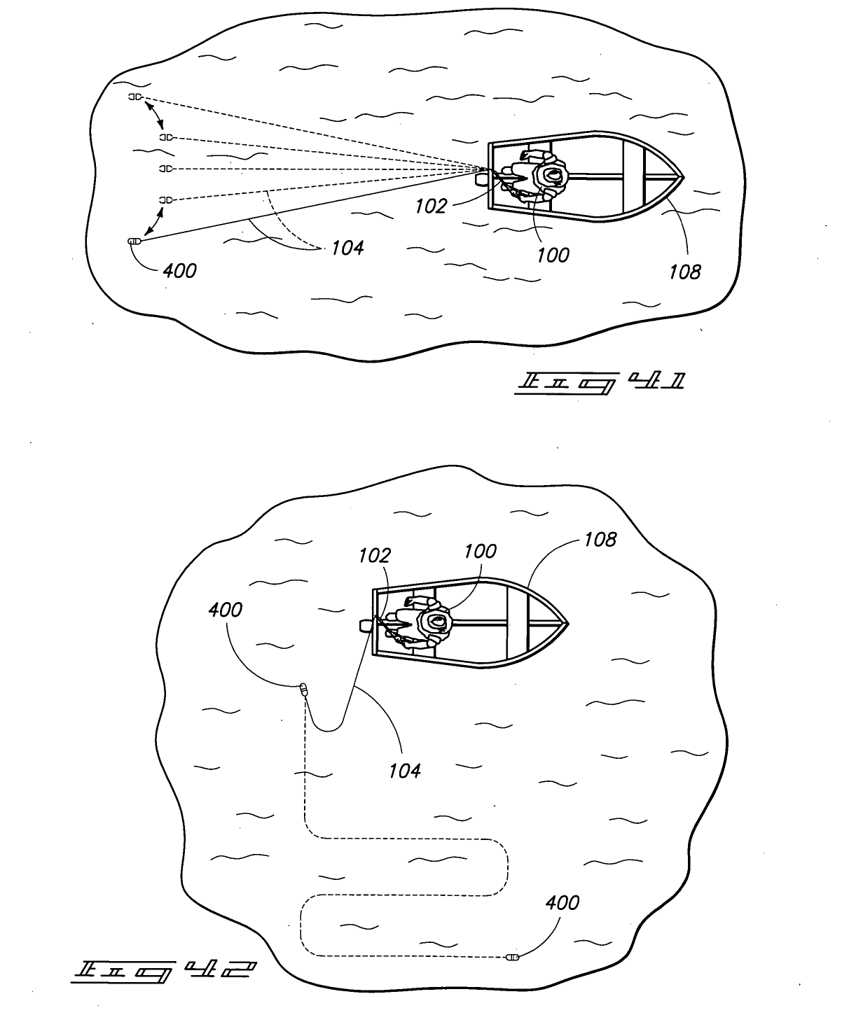

FIG. 38 illustrates one exemplary DC motor 148 having a motor housing 406.

FIG. 39 illustrates a wind-up motor having an internal coil spring for driving a fishing apparatus, such as a lure or bobber.

FIG. 40 shows a second alternative motor construction comprising a gasoline motor 348 usable in a fishing apparatus such as a self-propelled bobber (or lure).

FIG. 41 illustrates navigation of a remotely-controlled lure 400 on the top surface of a body of water behind a trolling vessel comprising a motorized boat 108.

FIG. 42 illustrates navigation of a self-propelled and remotely-controlled bobber 400 across the top surface of body of water which has been navigated from a boat 108 by an angler 100 without casting bobber 400 from a first position to a second position across a navigable course.

FIG. 43 is a plan view illustrating navigation of a bobber 400 from a first position to a second position after an angler 100 has cast the bobber from a boat 108.

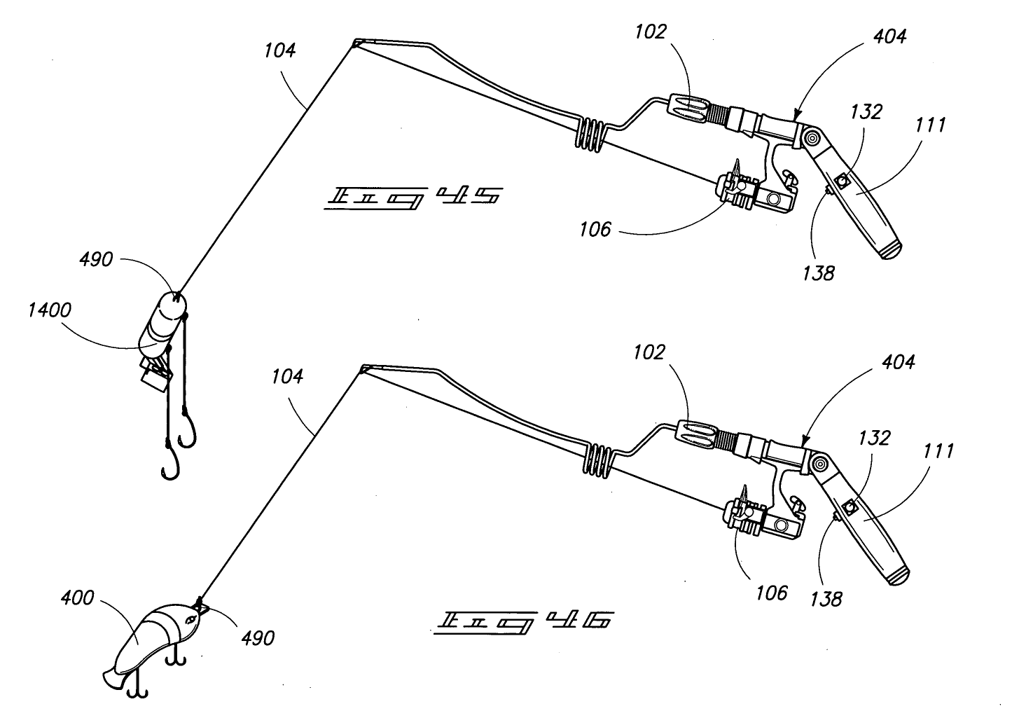

FIG. 44 illustrates navigation of a remotely-controlled and self-propelled fishing lure 400 from a first position to a second position beneath the surface of the water.

FIG. 45 illustrates a fishing pole 102 with a handle component 111 having a transmitter therein for controlling a self-propelled bobber 1400. A reel 106 is affixed to a reel seat 404. A joystick 132 and an on/off switch 138 are visibly positioned on handle component 111.

FIG. 46 illustrates a fishing pole 102 with a handle component 111 having a transmitter therein for controlling a self-propelled lure 400. A reel 106 is affixed to a reel seat 404. A joystick 132 and an on/off switch 138 are visibly positioned on handle component 111.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A transmitting control device for remotely controlling a navigable fishing apparatus, comprising:
a fishing pole having a handle;
a transmitter provided in the handle; and
at least one input device supported by the handle and electrically coupled with the transmitter to generate input signals from the transmitting control device for controlling a remotely controlled and navigable fishing apparatus.
